(19) United States
(12) Patent Application Publication
(10) Pub. No.: US 2026/0127026 A1
(43) Pub. Date: May 7, 2026

(54) SYSTEMS AND METHODS FOR DATA DISTRIBUTION

(71) Applicant: LIFE TECHNOLOGIES CORPORATION, Carlsbad, CA (US)

(72) Inventors: Christopher Cole, Bend, OR (US); Sean Grady, Portland, OR (US)

(21) Appl. No.: 19/117,514

(22) PCT Filed: Oct. 9, 2023
(86) PCT No.: PCT/US2023/034758

§ 371 Date: Apr. 1, 2025

Related U.S. Application Data
(60) Provisional application No. 63/379,090, filed on Oct. 11, 2022.

(51) Int. Cl. G06F 9/48; G06F 9/50

(52) U.S. Cl. CPC G06F 9/4881; G06F 9/5027; G06F 2209/486; G06F 2209/5013

(57) ABSTRACT

Methods and systems for data distribution are described herein. In one aspect, a method can include receiving, by at least one worker node (WN) 110 of a plurality of WNs of a data distribution system, a job definition from a job manager, wherein the job definition comprises a set of processes to be performed on a set of data request; sending, by the WN 110 and to an extended binary access manager (BAMEx) 140, a request for the data; receiving, by the WN 110 and from the BAMEx 140, the data based on the request for the data; performing, by the WN 110, one or more processes according to the job definition; generating, by the WN 110, a set of results files comprising results of at least one of the performed one or more processes; and sending, by the WN 110, the set of results files to the BAMEx 140.

### TECHNICAL FIELD

The disclosed technology relates to the field of data distribution systems.

### BACKGROUND

Several types of data distribution platforms exist for customers to store and retrieve their data. For example, third-party data persistence and distributed computing solutions have been engineered that require a customer to license a known and remotely managed solution. Platforms such as Amazon Web Services™ (AWS™), Microsoft™ Azure™ Cloud, Google Cloud Services (GCS) all employ this model.

As another example, third-party data persistence and distributed computing solutions exist within the Open Source domain. These solutions however do not attempt to agnostically allow for the employment of any combination of third-party licensed solutions like AWS, Azure, and GCS. These solutions rely on internal or external networked computers that are known to the governing system. For example, these systems are not agnostic of the data persistence, computational mechanisms, etc. Further these systems are not extendable to support any number of persistence and computation domain models. For example, implementing both AWS and Azure platforms simultaneously.

However, these solutions do not allow for the ability to modify any number of previous modifications of any behavior using any of number of common or proprietary scripting solutions. In other words, these solutions provide a single layer of modification that themselves use a single scripting solution.

There exists a need for a system that allows customers to persist their data across any number of disparately located storage platforms, and to then perform collocated distributed calculation on this data such that the data persistence, data transfers, data computations can be done agnostically from the scientific applications and instruments that may generate large volumes of data, in an optimized and extensible way.

### SUMMARY

Methods and systems for data distribution are described herein. In one aspect, a method can include receiving, by at least one worker node (WN) of a plurality of WNs of a data distribution system, a job definition from a job manager, wherein the job definition comprises a set of processes to be performed on a set of data request; sending, by the at least one WN and to an extended binary access manager (BAMEx), a request for the set of data; receiving, by the at least one WN and from the BAMEx, the set of data based on the request for the set of data; performing, by the at least one WN, one or more processes according to the job definition; generating, by the at least one WN, a set of results files comprising results of at least one of the performed one or more processes; and sending, by the at least one WN, the set of results files to the BAMEx for storage.

Further, each subcomponent or module of the described methods and system can be extended by an interpreted script integrator (ISI). The ISI can be customized using an extension framework (ExFrame) proprietary scripting language. The ExFrame can extend or modify any of the preceding methods and systems.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIGS. 1-10 depict systems for data distribution according to the present disclosure.

FIG. 11 depicts a process for data distribution according to the present disclosure.

FIG. 12 depicts a computing device for performing an aspect of data distribution according to the present disclosure.

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps may be performed in any order. Any documents cited herein are incorporated by reference in their entireties for any and all purposes.

In addition, as used herein, the phrase “based on” should be understood to mean “based at least in part on,” unless otherwise specified.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any sub combination. Further, reference to values stated in ranges include each and every value within that range. In addition, the term “comprising” should be understood as having its standard, open-ended meaning, but also as encompassing “consisting” as well. For example, a device that comprises Part A and Part B may include parts in addition to Part A and Part B, but may also be formed only from Part A and Part B.

Systems where, for instance, microscopy data is generated, such as in the field of flow cytometry, typically export data generated in the system into a standard format (e.g., .fcs format), then manually copied and/or moved to new locations for additional analyses. As an example, this copying/moving of the data can occur via a thumb drive from a computer that generated or initially received the data, which can then be inputted into another storage container, such as another computer. However, in cases where high volume of data is generated, such as in cases where the dataset includes images, convention copying and storing of the generated data is very difficult to accomplish (e.g., a user can move a small subset of the data at a given time).

Additionally, internal IT security within a customer's system (e.g., a microscopy lab system) may be unknown to a data distribution system. Conventional storage systems, such as convention cloud computing, therefore, are cumbersome to implement, as integration of a third party data distribution system would also have to typically loosen security measures of the customer's system. A need is felt for a data storage system that allows for universally reachable high volume data persistence, where users are agnostic to data storage system.

Systems and methods for data distribution and persistence are described herein. By implementing the data distribution system, any user can extend data persistence, transfer, and distributed calculations such that the solution is completely extensible and authorable. Any number of initiating, contributing, or consuming client applications are agnostic of the internal persistence, collocation, or distribution of the data. Thus, any number client applications and/or servers can instantiate, contribute to, and/or consume persisted or generated data that the system manages or produces.

Further, any user can define their own heuristics and behavior, which can add to, replace, or remove existing system behaviors. A user of the system can write scripts that add, derive, override, or remove behavior agnostic of the underlying code implementations of the system. Any number of commonly or proprietary scripting languages may be employed by a customer to modify the behavior of the system such that the system's behavior performs custom work necessary for the customer.

The deployed system can also be unaware of any other system or persistence mechanism implemented in combination with the deployed system. Further, no proprietary data, algorithms, or configurations are shared outside of the user's (e.g., customer's) domain. There is no obligation to connect a user's domain to any third-party server to persist or capture data, including commercial data distribution systems.

The system described herein can include a variety of uncoupled components that can work in concert with one another (e.g., a “plug-and-play” type system). Thus, it may be possible to employ a single component without the need to employ other components of the system. Each component of the disclosed systems is provided below.

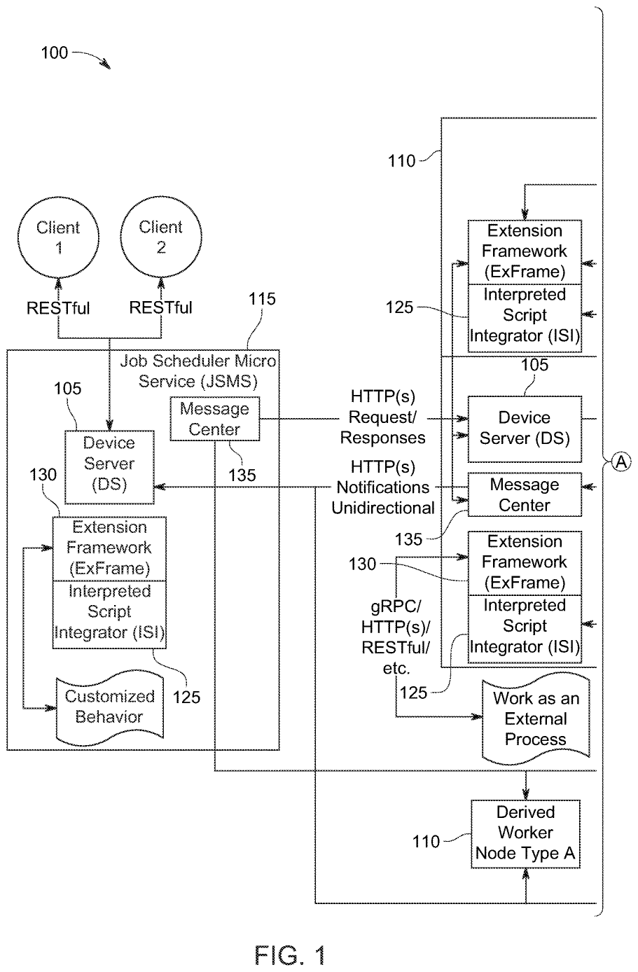

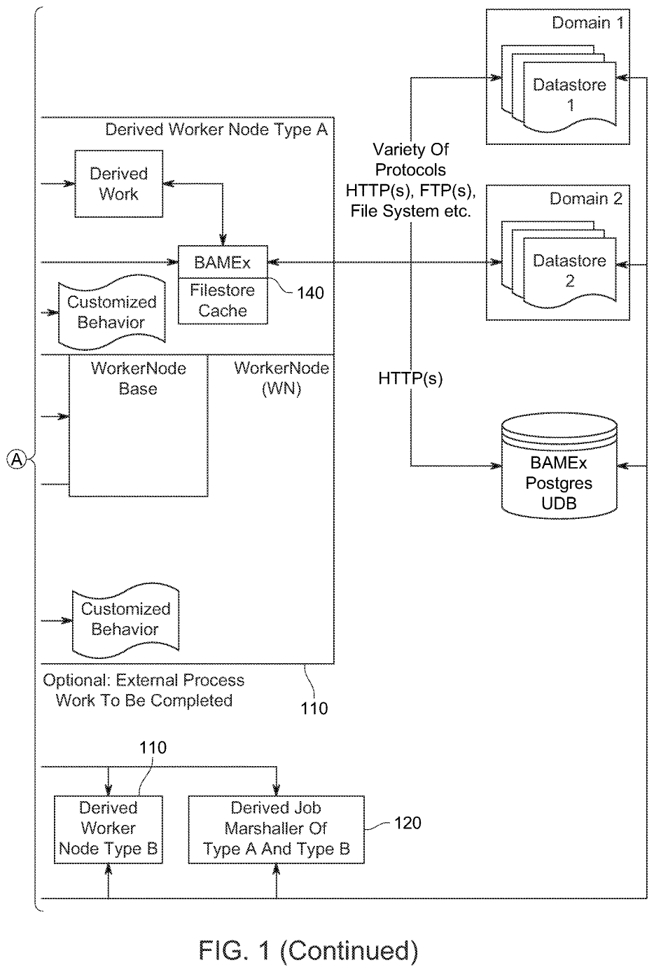

FIG. 1 depicts a system 100 for data distribution according to the present disclosure. The system can include a device server (DS) 105. The DS can be a RESTful server application that sits on top of a web server (e.g., a lightweight HTTP(s) server). For example, LibWebSockets may be implemented as the web server. However, the DS can be an abstraction, and the underlying server can be agnostic to the end client applications. Further, the DS 105 can be instantiated within an application to introduce the DS to the system. In some cases, communication to the DS 105 relies on a POST method within REST, and can take the form of JSON formatted payloads.

DS 105 can provide API contract declaration, introspection, and validation for the system. This can allow the DS to enforce client/server API contracts and can further provide a mechanism for applications to retrieve this API and declaration, which can dynamically provide API validation at run time. Integration of a callback system that defines the work of an endpoint client can utilize the payload subcomponent to enforce the contract between endpoint declaration (within the DS) and the application that defines the work of the endpoint (within the application). Furthermore, in cases where a DS is attached on both sides of a microservice architecture, the DS can provide push notifications such that one server can natively speak to another via a Message Center (described below).

The system can also include a message center (MC) 135. The MC can be a common component to provide “push” technology to receiving subscribers. Subscribers can be agnostic to the described system; for example, a subscriber can subscribe (e.g., via third-party tools) to a JSMS of the system for specific message. Within the described system, both the sending and receiving microservers can engage DSs as listeners and MC 135 135 can act as their complements. In some cases the MC can be a part of other components of the system.

As such, MC 135 can provide a certain amount of communication optimization between these two related components. MC 135 can also be implemented for any other components within the described system. MC 135 can utilize payloads to bind the application to the MC. MC 135 can translate the payloads to a JSON formatted POST requests via REST.

The system can also include an interpreted script integrator (ISI) 125. ISI 125 can support the extension framework that is integrated into many of the other components, for instance the BAMEx, DS, WN, and Job Scheduler Microservice (JSMS).

ISI 125 can provide a cascading callback solution that relies on the declaration and dynamic injection of ISI scopes onto the ISI's scope stack. The scope stack can be a literal stack of callback resolution domains that declare callback scripts with an associated interpreted scripting language. (It should be noted that interpreted scripting languages can include, for example, a strictly type language bound to the ISI as an interpreted scripting language, (e.g., C#)).

Callback resolution within ISI 125 can bind keywords to script callbacks. The ISI can use the scope stack to resolve the script callback based on the cascading nature of the order of the scopes pushed onto the scope stack. Payloads can be utilized to bind interpreted scripting languages to the application (e.g., via the ISI scope stacks).

ISI 125 can be a subcomponent of an application. ISI 125 can be instantiated, but it can also have multiple instances within the same application. This allows for an application designer to set aside an instance of ISI 125 to perform certain types of work while another instance of ISI 125, also in the same application, might be responsible for another type of work. For example, ISI 125 might be instantiated with an application that itself instantiates DS 105. DS 105, by its nature, already instantiates an instance of ISI 125. In this case, the application designer can choose to have a single ISI instance serve both the application and the DS. Or conversely the designer might choose to have two separate ISI instances governing each of the two use cases.

The system can also include a worker node base (WN) 110. The WN can establish a base worker whereby processes can be executed on a dataset in one of two methods. First, work can be executed via ISI 125 through the extension metaphor established by the ISI. Second, work can be executed as a derived worker node that natively extends the virtualized API within the base WN 110. This can be referred to as subclassing the base WN. Subclassed WNs can also employ the first method and extend its functionality via the ISI extension framework.

Worker nodes can declare themselves, for example, with a “name: address” and “type”. This information can allow a Job Scheduler Microservice (JSMS) 115, which can support enqueuing many different WNs over any number of logical domains, or an invoking client application, to issue jobs that can be consumed by worker nodes of the specific WN type. A collection of worker nodes of a specific type within the same logical domain can create a “worker farm” of the specified type within the specified domain. JSMS 115 will be described later in this disclosure.

WN 110 can include a DS and MC as described herein. A JSMS 115 can register with the MC of the worker node to receive events (e.g., via JSON formatted REST POST requests). Jobs, represented as payloads, can be bound to the worker node via a native (C++) payload subcomponent. Once represented as a payload, the jobs are passed to a derived worker node to perform work (e.g., processes) dictated by the definition of a derived worker node (e.g., CAFWrapper, and the like). Examples of work that a worker can performed include, but are not limited to: clustering analysis of the data; supervised or unsupervised learning or training according to the data; decomposition of data into datasets; recomposition of data into larger datasets; calculations performed on the data (e.g., single stage calculations, multi-stage calculations, distributed calculations, and the like); and data queries for data location according to query parameters.

The system can also include a JSMS 115. JSMS 115 can support enqueuing many different WNs over any number of logical domains. A logical domain can be a construct that allows for persisted data to be associated (e.g., collocated) with WNs of a specific type. In some cases, a domain can support any number of WN types. Any number of invoking clients can enqueue any number of jobs that are assigned by JSMS 115 to available WNs of the necessary type within the specified job domain. Thus, data located within one domain can be processed against a worker farm of the specified type within that same domain. As an example, one or more jobs may be issued to JSMS 115 that request for image processing of data residing within S3 buckets of a region of a cloud system (e.g., AWS). A pre-existing (or dynamically instantiated) worker farm can then be assigned these jobs. This allows for WNs to process data within the same domain, thereby reducing data transmission impacts and monetary costs.

JSMS 115 can also be responsible for centralizing and managing the distributed work across any number of worker farms and across any number of logical domains. JSMS 115 can also be responsible for fault conditions such as a dropped worker node or timed out job execution.

JSMS 115 can also utilize a DS and a MC to manage and manipulate queued jobs. Jobs can be payloads that are passed to the JSMS (e.g., as a JSON-formatted REST POST request). The underlying job objects can be marshalled into payloads within the JSMS and can be managed within maps and lists maintained by the JSMS (e.g., as native C++ objects).

The system can also include a job marshaller (JM) 120. JM 120 can be a “super object” allowing for a single embedded DS to route messages from external clients (e. g., a JSMS or native application) to any number of embedded WNs. These embedded WNs may not contain an embedded DS or MC and refer natively to the JMs embedded DS. JM 120 can facilitate for any specific machine (computer) to be fully saturated. Thus, all resources can be both shared and fully utilized by the collection of sub-WNs contained with JM 120.

The system can also include an extension framework (ExFrame) 130. ExFrame 130 can include a proprietary interpreted scripting solution that can provide a clean and agnostic mechanism for users to develop custom behaviors by overriding nodes within a declarative node graph. ExFrame node graphs can be developed whereby nodes within the graph can be individually overridden by users to perform their own desired behavior. This provides a declarative and validated software development kit (SDK) solution.

In short, ExFrame 130 can provide an interpreter that can register declarative and validated node graphs. Any number of node graphs can be declared, and, like traditional ISI scopes, these graphs can be bound to keyword callbacks. ISI 130 can then resolve these keywords to their scoped scripts. When such resolution identifies an ExFrame node graph the ExFrame interpreter can execute on the node graph, at which point ISI 130 has resolved the invoking callback keyword. Execution of the nodes within a graph can resolve against other callbacks also registered to the ISI within other scopes on the scope stack. Additionally, similar ISI 130, any number of ExFrames can be instantiated within an application.

The system can include an extended binary access manager (BAMEx) 140. BAMEx 140 can centralize access to data as binary blobs, such that the persistence location of the data is obfuscated from an invoking client application. BAMEx 140 can also manage the lifecycle and maintenance of the binary data. For example, BAMEx 140 can relocate binary blobs based on overridable heuristics (see, e.g., ISI 125 described below such that less frequently accessed data may be relocated periodically farther from consuming worker nodes (see, e.g., WNs described below) and client applications.

BAMEx 140 can be an instantiated component that is embeddable in another application. BAMEx 140 can utilize an extension model that allows for various datastore types (e.g., local file systems, AWS S3, AWS EBS, AWS EFS, AWS Glacier, Azure Blobs, and the like). BAMEx 140 can manage these datastores, and the data contained within a respective datastore, via a universally reachable database (UDB). Some behaviors of BAMEx 140 can be customized using the ISI override subsystem. For example, backup strategies might be written to override the built in backup heuristic provided by the BAMEx base.

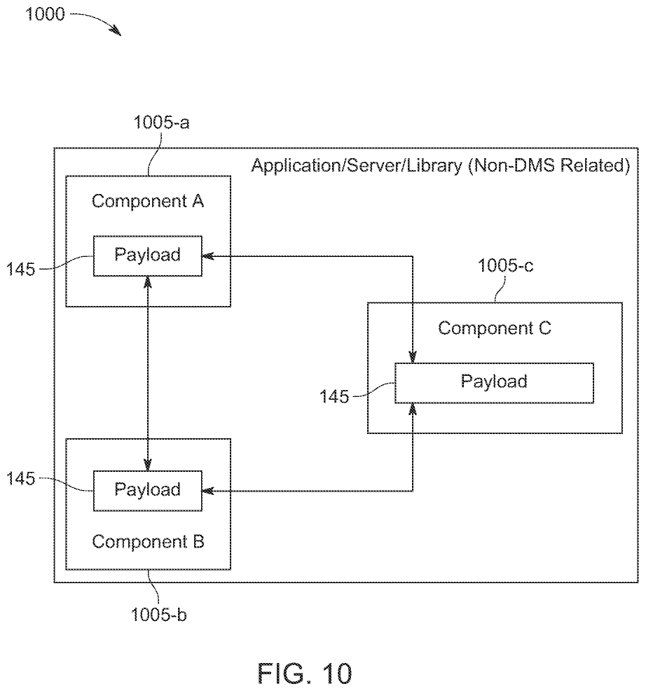

The system can also include a payload construct (Payload) 145 (shown in FIG. 10). The payload allows the described system to bind transfer protocols and scripting languages to the native code (e.g., strictly typed C++) . This dynamic binding can agnostically abstract bound objects to the components of the described system (e.g., DS, JSMS, WN, BAMEx, ExFrame, etc.).

Payload 145 can be used to exchange information between components seamlessly. Payload 145 can utilize a polymorphic inheritance architecture that separates first class citizens (which can be added to the hierarchy at will) from underlying serialization techniques (e.g., HTTP(S), GRPC, TCP/IP, JSON, XML, CSV, etc.). By supplying this abstraction the component architecture and code design of the described system can consume payload objects, but can subsequently transfer these objects to other components and protocols agnostic of the governing component code. The payload can be a native code linked to an application. Embedding a system component or subcomponent can link in the payload modules. Thus, if an application utilizes any of the system components or subcomponents, the payloads of the system are linked to those components and subcomponents.

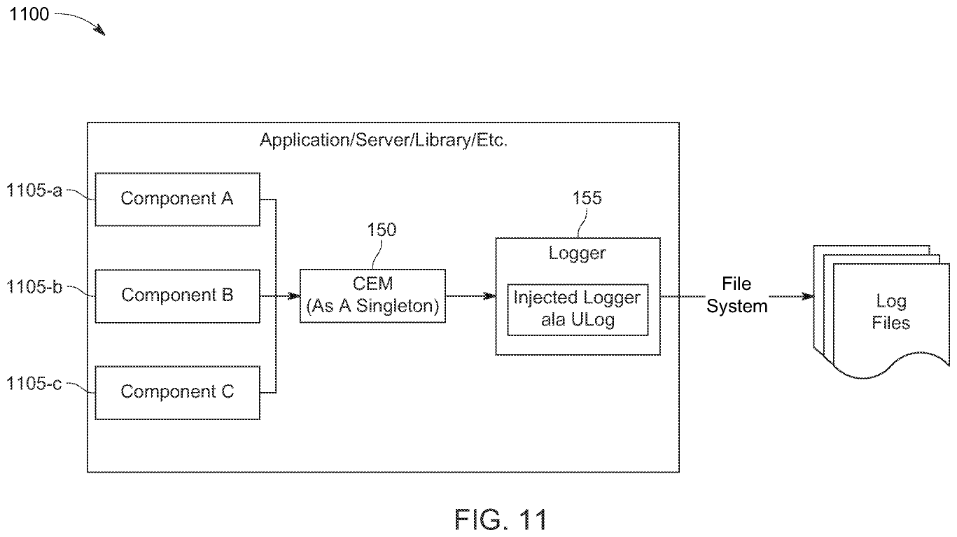

The system can also include a Common Error Manager (CEM) 150 (disclosed in FIG. 11). Error management within this collection of uncoupled components of the described system can be implemented CEM 150. This component can be used in all, or some, of the components of the described system. CEM 150 can provide a mechanism to register error codes (e.g., integer numbers) to error records. Error records can contain a human readable error string, error descriptions, and supplemental error information. CEM 150 can be a singleton instantiated at the initial invocation of an application.

Each component that employs CEM 150 can register a series of errors to CEM 150 instance. This registration system guarantees the uniqueness of both the error code and error record. In this way components of the system are free to register their own necessary errors regardless of what other components have been previously registered. CEM 150 solves a subtle issue caused by the “plug-and-play” notion of the uncoupled component architecture of the system.

The system can also include a Universal Logger (ULog) 155 (shown in FIG. 11). ULog 155 can work with CEM 150 to provide a consistent logging solution that natively consumes the CEM error codes and error records. The ULog can further generate consistent, formatted (e.g., JSON-based) log records that can be sorted, presented, and mined through a proprietary log viewer.

Components and subcomponents of the system can be set up, or introduced, in a few ways. For example, a component can be instantiated, such as for the DS, MC, JSMS, WN, JM, and the like. In some cases, a component can be introduced to the system via a singleton pattern within an application, such as for the CEM, ISI, and ExFrame. In some cases, a component is introduced via native module (e.g., C++) module inclusion, such as for the payload. For instantiation, instantiated objects (e.g., the DS, MC, JSMS, WN, JM, and the like) can be managed at the native application level.

In particular, FIG. 1 depicts a system 100 where two clients interact with a universally reachable JSMS 115. The clients can enqueue jobs to the JSMS 115. The JSMS 115 can manage the execution of these jobs over several workers node (WN) 110. There are two flavors of worker node 110, Type A and Type B in the system 100. Similarly, jobs requiring WNs 110 of Type A are sent to available WNs 110 of Type A. Similarly jobs requiring WNs 110 of Type B are sent to available WNs 110 of Type B. The system 100 also includes a JM 120, which can contain both WNs 110 of Type A and WNs of Type B. The JSMS 115 can send jobs to the JM 120 when an associated WN type becomes available within this JM 120.

Depicted in the system 100 is an exploded WN 110 of Type A In this exploded view of the WN 110, the WN 110 can be seen to extend its default behavior via the ExFrame 130 and ISI 125 using custom scripts. The WN 110 also communications with an external process that has been developed without regard for the system 100.

The system 100 also illustrates that derived work of the WN 110 overrides behavior with custom scripts via the ExFrame 130 and ISI 125. Further the derived work instantiates a local BAMEx 140 instance (within the WN application) which interacts with the universally reachable SQL DB (UDB). Data is managed by the BAMEx 140 to persist and retrieve data from two datastores located in two separate Domains, Domain 1 and Domain 2.

Certain components of the described system can be used in a completely cohesive manner (e.g., no coupling) within other components. For example, the Payload can be used ubiquitously as a common commodity that binds the native (e.g., C++) code to both external communication protocols (e.g., HTTP(s), TCP/IP, GRPC, etc.) and interpreted scripting languages (e.g., Python, R, ExFrame, JavaScript, C#, etc.). Similarly, the CEM and ULog can be implemented throughout all components within the solution domain. However, these subcomponents can also be cohesively ingested by the governing components. Thus, there can be no coupling of these components. The coupling that does occur within the system can include singleton instantiations of CEM and ULog.

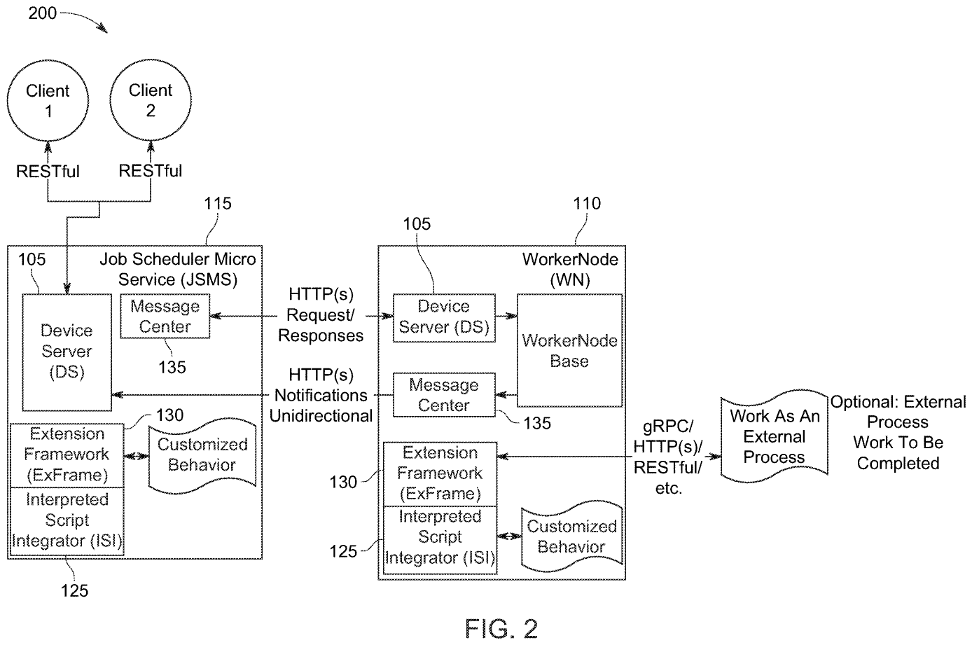

FIG. 2 depicts a system 200 for data distribution according to the present disclosure. The system 200 can include a DMS topology that include a JSMS and a WN (e.g., with no derived subclass for unique work.) In this case, the WN is implementing the ExFrame 130 to extend the basic functions of the WN to call a pre-existing external process. This particular system setup demonstrates that by virtue of the ExFrame 130 and ISI 125, the WN can invoke complex legacy systems with no code changes to the legacy system.

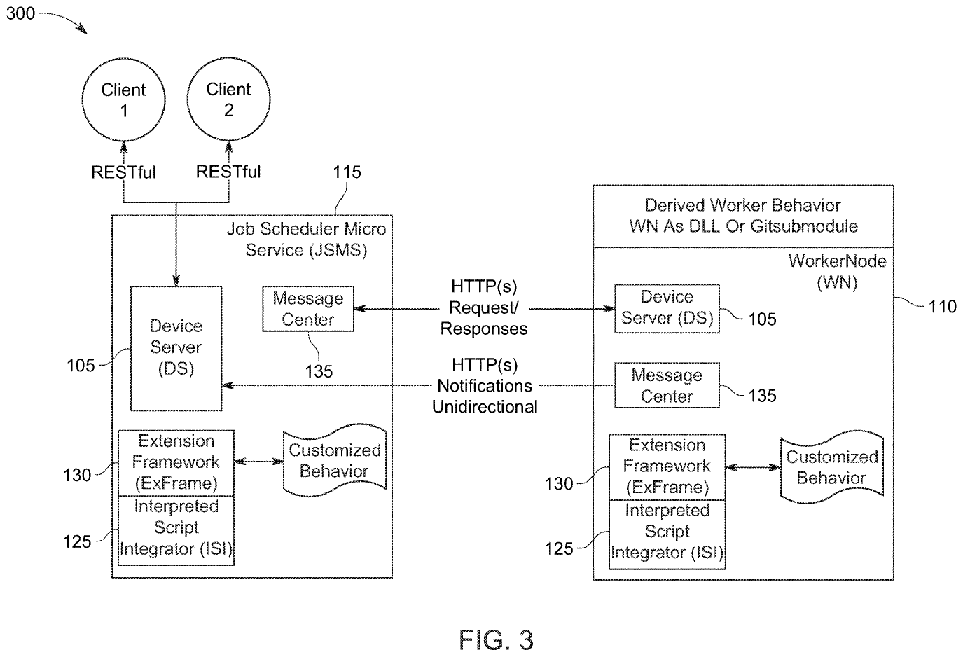

FIG. 3 depicts a system 300 for data distribution according to the present disclosure. The system 300 illustrates a WN subclassed (e.g., via C++) to extend functionality (e.g., to perform work). The derived WN can be attached to a base JSMS. For example, the system 300 can be used to perform complex machine learning/artificial intelligence (ML/AI) image processing on vast quantity of images.

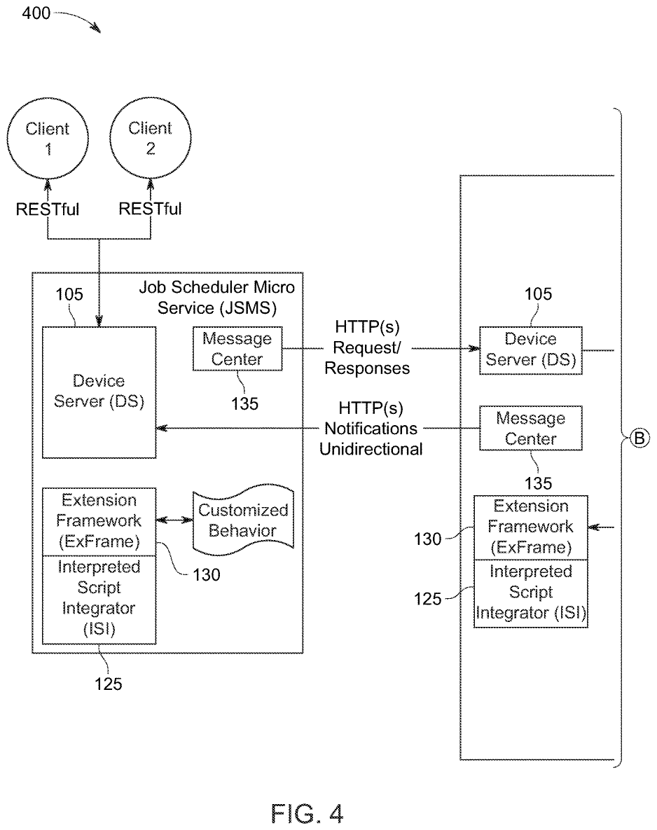

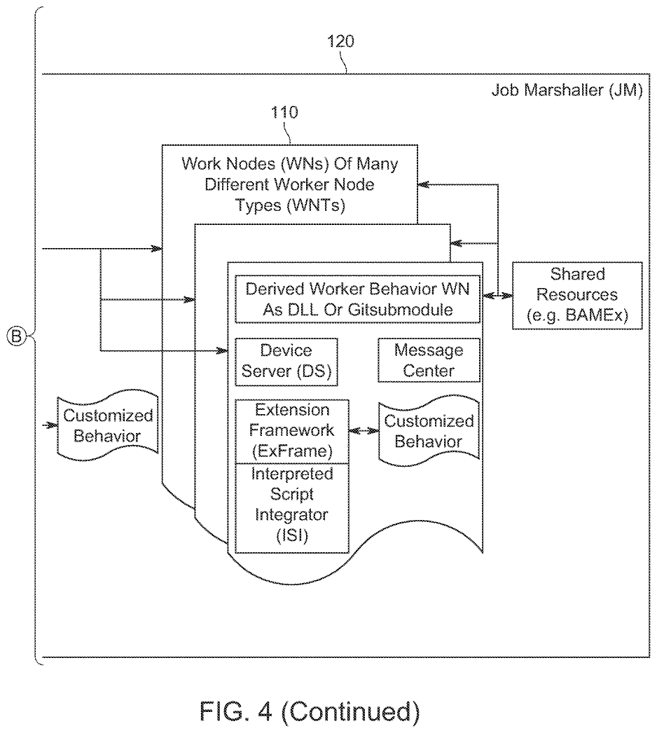

FIG. 4 depicts a system 400 for data distribution according to the present disclosure. The system 400 can include a JM to utilize and share resources on the same box (e.g., a single JM can optimally deploy any number of WNs and share resources like GPU, memory, filesystem, etc.) This allows for high end boxes (e.g., having a large number of CPU or central processing unit cores, high memory, high end GPU(s), SSDs, etc.) to be optimally utilized by the JM.

For example, a single box may deploy a WN that utilizes a GPU and 4 CPU cores along with 4 WNs utilizing 4 CPUs. All 5 WNs can then optimally “share” memory and IO resources. Thus, inter process communication, or complex data serialization (http, gRPC, etc.) can be mitigated.

The JM can also “emulate” virtual WNs. This concept allows for the transient processes to be deployed agnostic of the rest of the DMS deployed topology. For example, any number of computing instances (e.g., AWS Lambda) can be instantiated, invoked, and/or destroyed by the JM. The JSMS, for instance, only “talks” to the JM which delegates these commands to the transient computing instances.

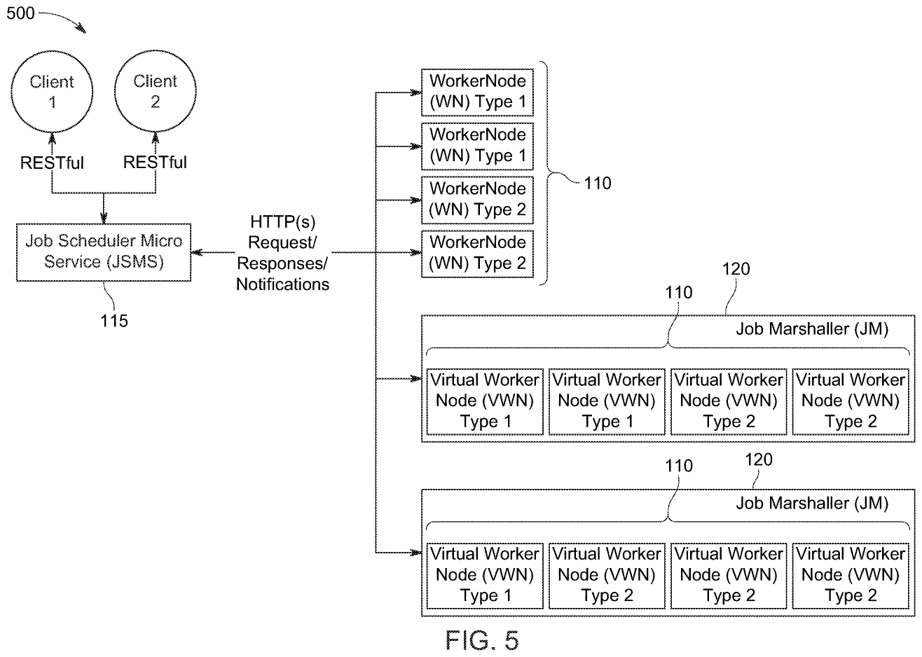

FIG. 5 depicts a system 500 for data distribution according to the present disclosure. The system 500 includes WNs of potentially many “types” as single instances as well as many JMs containing many WNs of many types. In the system 500 the WNs and JMs can optionally be deployed over many “domains.” The JSMS can be “universally reachable” within the IT universe provided by the end user.

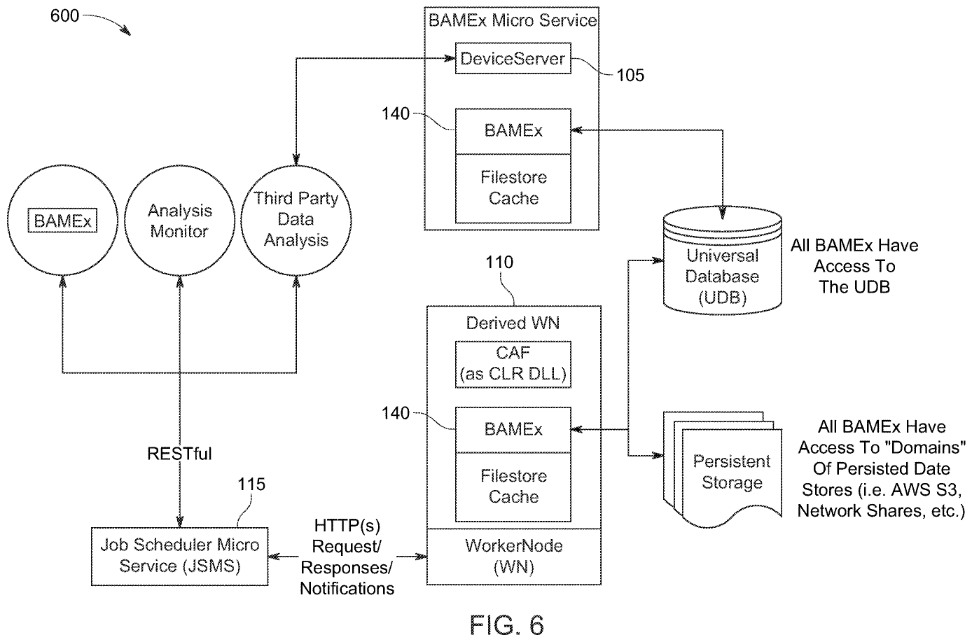

FIG. 6 depicts a system 600 for data distribution according to the present disclosure. The system 600 can include a single universally reachable JSMS communicates to any number of deployed subclassed WNs. These derived WNs can be specifically coded to process batches of images (e.g., where a batch include greater than 100K images). In some cases, these derived WNs utilize a CLR bridge to connect the WN (e.g., C++ based) to the derived “work” (e.g., C#based). The system 600 can include a single universally reachable BAMEx that is available for optimized data sharing over one or more domains. As an example, domains may include: AWS, Azure, LAN, etc.

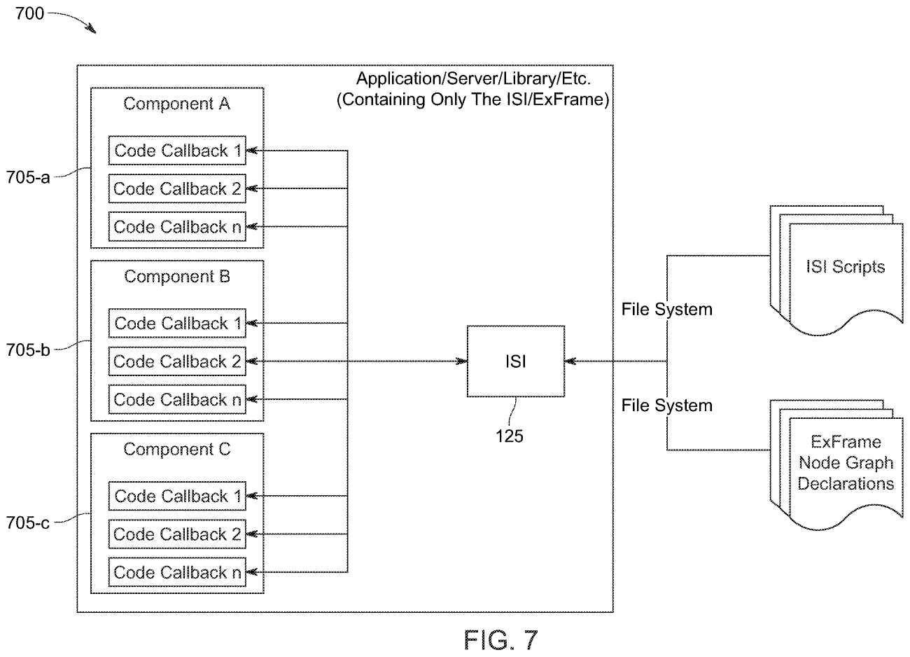

FIG. 7 depicts a system 700 for data distribution according to the present disclosure. Th system 700 illustrates how an ISI 125 can override any number of code callbacks within any number of application subsystems. As shown, the ExFrame 130 is simply additional declarative node graphs (similar to ISI scripts.) Thus, the ISI 125 can manage a scope stack of callback resolution domains that declare callback scripts with an associated interpreted scripting language across various components 705-a-c of the system 700 such as, but not limited to, DS, WN, JSMS, and the like.

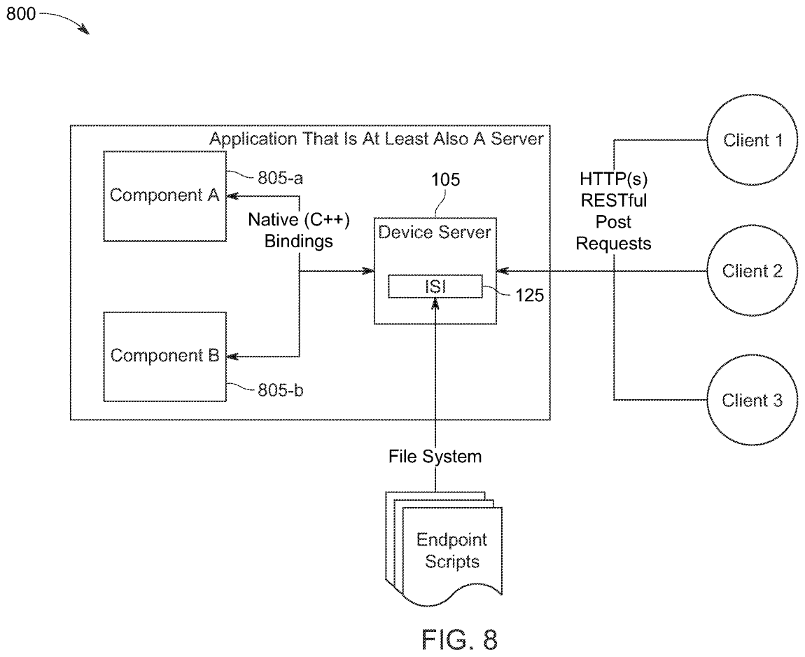

FIG. 8 depicts a system 800 for data distribution according to the present disclosure. FIG. 8 illustrates how a DS 105 can be added to an application (e.g., which can make the application a server). The DS 105 contains an ISI 125 which can allow for endpoints (e.g., clients 1-3) to be declared and bound to ISI scripts AND/OR for the ISI 125 to override the behavior of default native (C++) operations such that the ISI 125 resolves this behavior using its cascading scope stacks. Finally this diagram shows how the DS 105 natively (C++) callbacks to application components 805-a, 805-b, where components 805-a 805-b can be components of the system, for example, WN, JSMS, JM, and the like. The DS 105 can communicate with components 805-a, 805-b via native callbacks, whereas communications between the clients and the DS 105 can occur via RESTful POST requests. In a nonlimiting example, the DS 105 receives a RESTful POST request from a client. The ISI 125 can check the endpoint scripts to determine whether an overriding script of the DS function corresponding to the RESTful POST request exists. The DS 105 can communicate with components 805-a (e.g., a JSMS), 805-b (e.g., another DS), or both via native callback functions according to the RESTful POST request (e.g. which can include a payload) and the endpoint scripts.

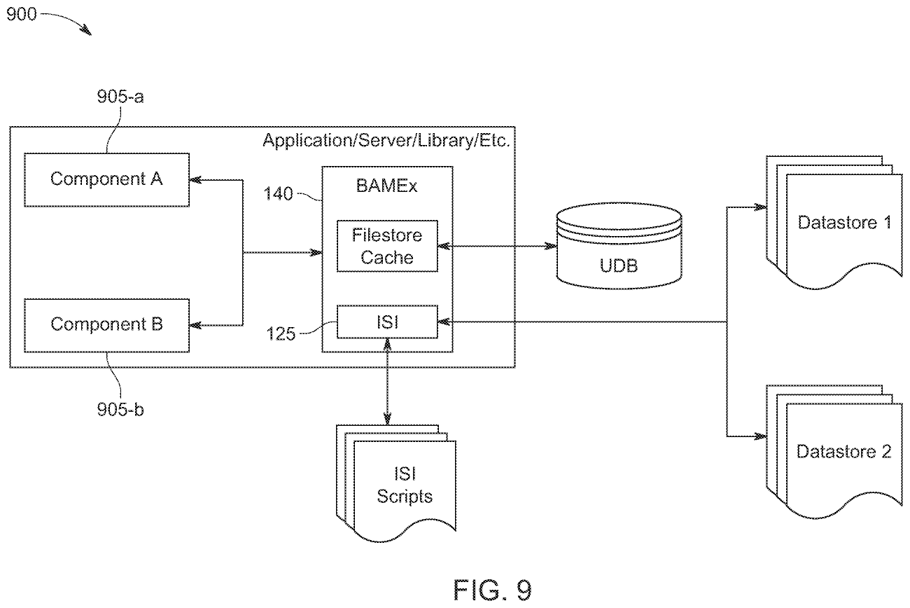

FIG. 9 depicts a system 900 for data distribution according to the present disclosure. FIG. 9 illustrates an instanced BAMEx 140 within an application. Two application components 905-a, 905-b (e.g., DS, JSMS, JM, WN, and the like) access the BAMEx 140 to persist and retrieve binary objects. The management of the data is held within the universal database (UDB). At least two datastores have been established that contain the binaries. The BAMEx 140 contains an ISI 125 which allows for default BAMEx behavior to be overridden by ISI scripts.

FIG. 10 depicts a system 1000 for data distribution according to the present disclosure. FIG. 10 illustrates shows three independent (decoupled) components 1005-a-c with some application/server/library/etc. that communicate through the dynamic nature of the payload. This configuration allows for one component to send complex objects between components, where such data schema can be loosely typed within the C++ strongly typed paradigm.

FIG. 11 depicts a system 1100 for data distribution according to the present disclosure. FIG. 11 illustrates how the CEM can be used as a standalone component within an application. The system 1100 can include three application components 1105-a-c (e.g., DS, JM, JSMS, WN, and the like) using the CEM to manage their error codes in a way that prevents error code enumeration conflicts. FIG. 11 also shows that the CEM can log error to the applications logging component, which typically uses an injectable logging implementation. In this case the Universal Logger (ULog) is shown.

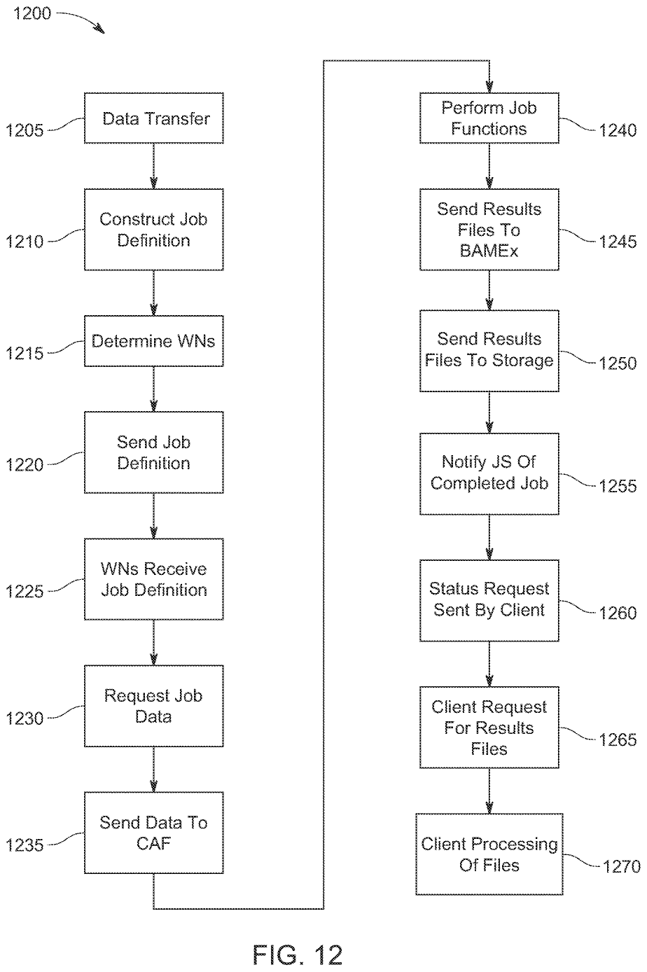

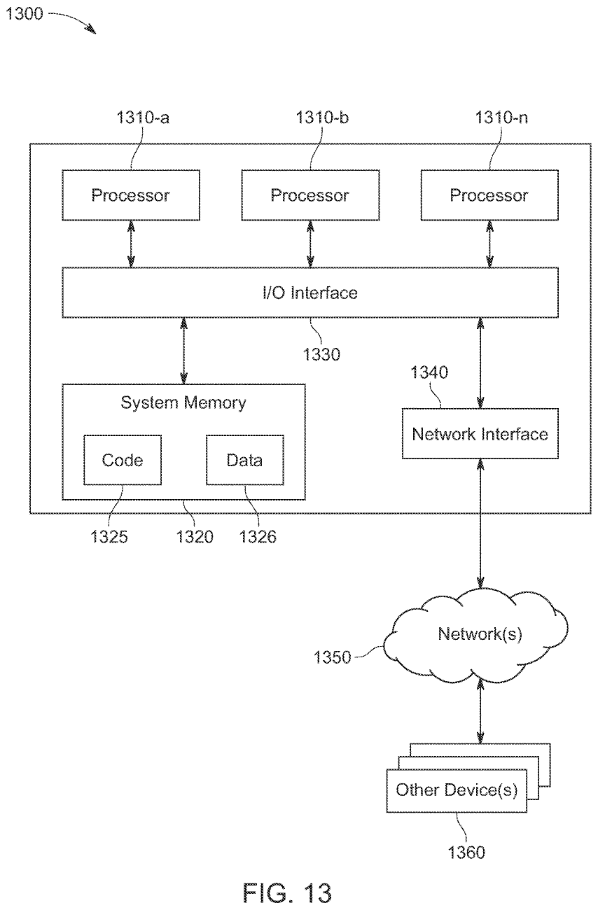

FIG. 12 depicts a process 1200 for data distribution according to the present disclosure. Steps 1205-1270 of process 1200 can be implemented by a data distribution system without any limitations, such as the system described in FIGS. 1-11.

At Step 1205, data can be transferred to a BAMEx to store in storage accessible by the system. For example, a client application can transfer files from local storage (e.g., a single board computer (SBC)) to the BAMEx. The BAMEx can subsequently transfer the files to a local file system, and links the data to a database (e.g., a uniform database UDB). For example, a heuristic maintained by the system can determine a location for a long-term persistence storage container (e.g., an AWS S3 bucket, a AWS Glacier, and the like). In some cases, an ISI of the system can allow for a user (e.g., a customer) to override or revise the heuristic of the system. In some cases, the BAMEx can also store the files in local cache in addition to, or in lieu of, storing the files in the local file system.

At Step 1210, a client application can construct a job definition payload. In some cases, the job definition payload can be constructed as a file format, such as JSON. In some cases, the client application can include an experimental analytical application, such as Attune. The job definition payload can be sent from the client application to JSMS (e.g., for enqueueing). The job definition payload can include, for example, Job ID, Job Meta Data, and Job Payload. The Job ID can be used for WN routing by the JSMS. The Job Meta data can define the specific request of the specific worker node of the specific type. Further, the Payload can pass any necessary data to the worker node to conduct the underlying job functions.

At Step 1215, the JSMS can determine one or more WNs for receiving the job definition. For example, the JSMS can determine a list of idle WNs. The WNs can be idle from working any jobs, or are not queued for working jobs. Further, the JSMS can determine a WN type. For example, a WN may be configured to perform a particular job (a particular image processing function, and the like). The JSMS can determine one or more WNs for receiving the job based on the availability of the WN, the WN type, and the like. In some cases, the determination can also be determined based on a collocation of the data for the job (e.g., a domain of the data). In some cases, the heuristic that the JSMS uses can be overridden by the ISI/ExFrame. Thus, control of how the JSMS decides where to send job definitions and to which WN and domain can be ultimately managed by a user (e.g., a customer) and the user's domain.

At Step 1220, the JSMS can send the job definition to the determined one or more WNs. The job definition can be sent via an application layer protocol, such as HTTP.

At Step 1225, the WNs can receive the job definition, and open the job definition. The job definition can contain one or more job parameters associated with the job. For example, the job parameters can be captured in the Job Metadata component of the job definition. Further, associated job data can be captured in the Job Payload component of the job definition. The job definition can be declarative, and can be validated via a DS.

In some cases, the behavior of a predefined WN type can be overridden by ISI/ExFrame. This can a user to change the behavior of the WN of a certain type. Further, in some cases the ISI/ExFrame can overwrite a WN type and declare the WN as a different type, prior to the WN registering with the JSMS. In this way a WN type that is similar to what a user desires can be modified and registered as a different WN type that the user has written in a scripting language. Further, scripting languages may not be required to recompile the original source. Thus, these types of data driven modifications to the subcomponents can be done agnostically of the distributed system.

At Step 1230, the selected WNs can, based on the job definition, request data from a BAMEx. The BAMEx, based on the identity of the job definition (e.g., an identity of the data to be retrieved), can further send a request (e.g., via TCP) to the database (e.g., the UDB) for access to the data. The database, in response, can send the BAMEx information on how to access the data. For example, the database can provide the BAMEx information on the location of the data (e.g., a particular database, a particular domain, and the like). The BAMEx can then fetch the data and relay the data to the WNs for the job. In some cases, the BAMEx can relay a file path of the data to the WNs, if the data is cached within a local file system (as opposed to the data being externally stored). The WNs can then fetch the data based on the file path. In some cases, the behavior of the BAMEx cache can be overridden with the ISI/ExFrame, so that when the BAMEx relies on the cache can be according to user preferences.

At Step 1235, the WNs can initiate the job function as provided in the job definition. For example, the derived work of the WN can perform any work on the data as necessary. However, the original data cannot be altered. The original data can be copied and modified or derived data can be created based on the data. In some cases, the job function can include feeding the data into a common analysis framework (CAF). The data feed can occur over, for example, a CLR bridge, which can connect the native language of the WNs (e.g., C++) to the language of the CAF libraries (e.g., C#). In cases where a CAF is implemented, the WNs can also send job parameters contained in the job definition to the CAF for performing the job.

At Step 1240, the job may be performed by the WNs. In the case of CAF implementation, the CAF can perform data analysis. For example, where the data includes images, the CAF can perform image data analysis and produce files (e.g., Masks & Extension File) containing the analysis results (e.g., cell morphology measurements). The images can be run through AI/ML models to generate mask and extended attributes. The results files can then be sent to the WNs. In some cases, data processing can be further pre and post manipulated using the ISI/ExFrame such that the underlying CAF and CLR bridge remain unchanged, but the user can preprocess the images, then post process the masks and extension data prior to it being sent to the BAMEx for persistence. In some cases, where a CAF is not involved, the WNs can perform the job functions as provided in the job definition, which can produce result files.

At Step 1245, the WNs can send the results files to the BAMEx. The results files can also include identification information, such as information associating the results files with the data fetched for the job, job identification, and the like.

At Step 1250, the BAMEx can sent the results files to storage (e.g., UDB and data store). In some cases, the storage can be chosen by ExFrame/ISI within the BAMEx.

At Step 1255, the WNs can inform the JS that the job is completed. In some cases, any errors encountered during the job execution can also be sent to the JS. The WNs can then set their status to “idle”.

At Step 1260, the client application can send a job status request to the JS. In some cases, the request can be sent through an application layer protocol, such as HTTP. The JS can send a response to the JS indicative of the job status (e.g., based on information provided by the WNs). The response can also include information on how to retrieve the results files from the BAMEx (e.g., identification information of the result files).

At Step 1265, the client application can send a request to BAMEx for the result files. The request can include identification information for the results files. The BAMEx can request the results files from storage (e.g., by first identifying the storage location). The results files can be sent to the BAMEx, which can cache, and then send the results files to the client application.

At Step 1270, the client application can process the results files for user viewing. For example, in the scenario where the results files include Masks and Extension files, the client application separate the mask files and the extension files, and can provide user viewing for the mask files and the extensions separate from one another. In some cases, the ISI/ExFrame can also be implemented with the client application to provide a controlled user extension exposure.

In at least some embodiments, an entity that implements a portion or all of one or more of the technologies described herein may include a general-purpose computer system that includes or is configured to access one or more computer-accessible media. FIG. 13 depicts a general-purpose computer system that includes or is configured to access one or more computer-accessible media. The example computer system of FIG. 7 may be configured to implement one or more of the services platform, the DS 105, WN 110, JSMS 115, JM 120, ISI 125, ExFrame 130, MC 135, BAMEx 140, or a combination thereof of FIGS. 1-11.

In the illustrated embodiment, computing device 1300 includes one or more processors 1310-a, 1310-b and/or 1310-n (which may be referred herein singularly as “a processor 1310” or in the plural as “the processors 1310”) coupled to a system memory 1320 via an input/output (I/O) interface 1330. Computing device 1310 further includes a network interface 1340 coupled to I/O interface 1330.

In various embodiments, computing device 1300 may be a uniprocessor system including one processor 1310 or a multiprocessor system including several processors 1310 (e.g., two, four, eight or another suitable number). Processors 1310 may be any suitable processors capable of executing instructions. For example, in various embodiments, processors 1310 may be general-purpose or embedded processors implementing any of a variety of instruction set architectures (ISAs), such as the x86, PowerPC, SPARC or MIPS ISAs or any other suitable ISA. In multiprocessor systems, each of processors 1310 may commonly, but not necessarily, implement the same ISA.

System memory 1320 may be configured to store instructions and data accessible by processor(s) 1310. In various embodiments, system memory 1320 may be implemented using any suitable memory technology, such as static random access memory (SRAM), synchronous dynamic RAM (SDRAM), nonvolatile/Flash®-type memory or any other type of memory. In the illustrated embodiment, program instructions and data implementing one or more desired functions, such as those methods, techniques and data described above, are shown stored within system memory 1320 as code 1325 and data 1326.

In one embodiment, I/O interface 1330 may be configured to coordinate I/O traffic between processor 1310, system memory 1320 and any peripherals in the device, including network interface 1340 or other peripheral interfaces. In some embodiments, I/O interface 1330 may perform any necessary protocol, timing or other data transformations to convert data signals from one component (e.g., system memory 1320) into a format suitable for use by another component (e.g., processor 1310). In some embodiments, I/O interface 1330 may include support for devices attached through various types of peripheral buses, such as a variant of the Peripheral Component Interconnect (PCI) bus standard or the Universal Serial Bus (USB) standard, for example. In some embodiments, the function of I/O interface 1330 may be split into two or more separate components, such as a north bridge and a south bridge, for example. Also, in some embodiments some or all of the functionality of I/O interface 1330, such as an interface to system memory 1320, may be incorporated directly into processor 1310.

Network interface 1340 may be configured to allow data to be exchanged between computing device 1300 and other device or devices 1360 attached to a network or networks 1350, such as other computer systems or devices, for example. In various embodiments, network interface 1340 may support communication via any suitable wired or wireless general data networks, such as types of Ethernet networks, for example. Additionally, network interface 1340 may support communication via telecommunications/telephony networks such as analog voice networks or digital fiber communications networks, via storage area networks such as Fibre Channel SANs (storage area networks) or via any other suitable type of network and/or protocol.

In some embodiments, system memory 1320 may be one embodiment of a computer-accessible medium configured to store program instructions and data as described above for implementing embodiments of the corresponding methods and apparatus. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computing device 1300 via I/O interface 1330. A non-transitory computer-accessible storage medium may also include any volatile or non-volatile media such as RAM (e.g. SDRAM, DDR SDRAM, RDRAM, SRAM, etc.), ROM (read only memory) etc., that may be included in some embodiments of computing device 1300 as system memory 1320 or another type of memory. Further, a computer-accessible medium may include transmission media or signals such as electrical, electromagnetic or digital signals conveyed via a communication medium such as a network and/or a wireless link, such as those that may be implemented via network interface 1340. Portions or all of multiple computing devices such as those illustrated in FIG. 13 may be used to implement the described functionality in various embodiments; for example, software components running on a variety of different devices and servers may collaborate to provide the functionality. In some embodiments, portions of the described functionality may be implemented using storage devices, network devices or special-purpose computer systems, in addition to or instead of being implemented using general-purpose computer systems. The term “computing device,” as used herein, refers to at least all these types of devices and is not limited to these types of devices.

A compute node, which may be referred to also as a computing node, may be implemented on a wide variety of computing environments, such as commodity-hardware computers, virtual machines, web services, computing clusters and computing appliances. Any of these computing devices or environments may, for convenience, be described as compute nodes.

Each of the processes, methods, and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

### EXEMPLARY EMBODIMENTS

The following embodiments are exemplary only and do not serve to limit the scope of the present disclosure of the appended claims. It should be understood that any part of any one or more Embodiments can be combined with any part of any other one or more Embodiments.

### Embodiment 1

A method for data distribution, comprising: receiving, by at least one worker node (WN) of a plurality of WNs of a data distribution system, a job definition from a job manager, wherein the job definition comprises a set of processes to be performed on a set of data request; sending, by the at least one WN and to an extended binary access manager (BAMEx), a request for the set of data; receiving, by the at least one WN and from the BAMEx, the set of data based on the request for the set of data; performing, by the at least one WN, one or more processes according to the job definition; generating, by the at least one WN, a set of results files comprising results of at least one of the performed one or more processes; and sending, by the at least one WN, the set of results files to the BAMEx for storage.

### Embodiment 2

The method of Embodiment 1, wherein the job manager is a job scheduler microservice (JSMS).

### Embodiment 3

The method of any of Embodiments 1-2, further comprising: receiving, by the JSMS and from the client source external to the data distribution system, the job definition comprising a request for a set of processes to be performed on a set of data; and identifying, by the JSMS, the WN of the data distribution system based on the job definition.

### Embodiment 4

The method of any of Embodiments 1-3, wherein the set of data is cached locally at the BAMEx, or stored external to the data distribution system.

### Embodiment 5

The method of any of Embodiments 1-4, wherein the set of data comprises a set of images.

### Embodiment 6

The method of any of Embodiments 1-5, further comprising: determining, by the BAMEx, a location of the set of data external to the data distribution system; and sending, by the BAMEx and to a storage location, a request for retrieval of the set of data based on the determined location, wherein the storage location is external to the data distribution system.

### Embodiment 7

The method of any of Embodiments 1-6, further comprising: determining, by the JSMS, a status for each of the plurality of WNs of the data distribution system, wherein the WN is identified based on the status.

### Embodiment 8

The method of any of Embodiments 1-7, wherein the status comprises a busy status, or an idle status.

### Embodiment 9

The method of any of Embodiments 1-8, further comprising: determining, by the JSMS, a type for each of the plurality of WNs of the data distribution system, wherein the WN is identified based on the type.

### Embodiment 10

The method of any of Embodiments 1-9, wherein the type comprises a data analyzer WN or a data derivation WN.

### Embodiment 11

The method of any of Embodiments 1-10, further comprising: storing, by the BAMEx, the set of results files in a local cache; and sending, by the BAMEx, the set of results files to storage external to the distribution system.

### Embodiment 12

The method of any of Embodiments 1-11, further comprising: receiving, by the BAMEx and from a client application, the set of data; determining a storage location for the set of data based on a heuristic maintained by the data distribution system; and sending the set of data to the storage location, wherein the storage location is external to the data distribution system.

### Embodiment 13

The method of any of Embodiments 1-12, further comprising: sending, by the WN to the JSMS, a notification of a busy status for the WN subsequent to the sending of the job definition to the WN.

### Embodiment 14

The method of any of Embodiments 1-13, wherein the WN is grouped with at least one other WN of the plurality of WNs to comprise a single entity as viewed by the JSMS.

### Embodiment 15

The method of any of Embodiments 1-14, further comprising: grouping, by a job marshaller (JM) of the data distribution system, the WN and the at least one other WN to comprise the single entity.

### Embodiment 16

The method of any of Embodiments 1-15, wherein the WN comprises a central processing unit (CPU).

### Embodiment 17

The method of any of Embodiments 1-16, further comprising: receiving, by the BAMEx and from the client application, a request for the set of results files; determining, by the BAMEx, a storage location of the set of results files according to a heuristic maintained by the data distribution system; retrieving, by the BAMEx, the set of results files from the storage location; and sending, by the BAMEx, the set of results files to the client application.

### Embodiment 18

The method of any of Embodiments 1-17, wherein a storage location for the set of data, and the storage location for the set of results files, are unknown to the client application.

### Embodiment 19

The method of any of Embodiments 1-18, wherein the client application refrains from communicating with a storage system for the set of data, and the storage location for the set of results files.

### Embodiment 20

The method of any of Embodiments 1-19, further comprising: sending, by the WN and to a common analysis framework (CAF), the set of data; wherein the executing the one or more job functions is performed by the CAF.

### Embodiment 21

The method of any of Embodiments 1-20, wherein the job definition originates from a client source external to the data distribution system.

1. A method for data distribution, comprising:
receiving, by at least one worker node (WN) of a plurality of WNs of a data distribution system, a job definition from a job manager, wherein the job definition comprises a set of processes to be performed on a set of data request;
sending, by the at least one WN and to an extended binary access manager (BAMEx), a request for the set of data;
receiving, by the at least one WN and from the BAMEx, the set of data based on the request for the set of data;
performing, by the at least one WN, one or more processes according to the job definition;
generating, by the at least one WN, a set of results files comprising results of at least one of the performed one or more processes; and
sending, by the at least one WN, the set of results files to the BAMEx for storage.

2. The method of claim 1, wherein the job manager is a job scheduler microservice (JSMS).

3. The method of claim 1, further comprising:
receiving, by the JSMS and from the client source external to the data distribution system, the job definition comprising a request for a set of processes to be performed on a set of data; and
identifying, by the JSMS, the WN of the data distribution system based on the job definition.

4. The method of claim 1, wherein the set of data is cached locally at the BAMEx, or stored external to the data distribution system.

5. The method of claim 1, wherein the set of data comprises a set of images.

6. The method of claim 1, further comprising:
determining, by the BAMEx, a location of the set of data external to the data distribution system; and
sending, by the BAMEx and to a storage location, a request for retrieval of the set of data based on the determined location, wherein the storage location is external to the data distribution system.

7. The method of claim 1, further comprising:
determining, by the JSMS, a status for each of the plurality of WNs of the data distribution system, wherein the WN is identified based on the status.

8. The method of claim 7, wherein the status comprises a busy status, or an idle status.

9. The method of claim 1, further comprising:
determining, by the JSMS, a type for each of the plurality of WNs of the data distribution system, wherein the WN is identified based on the type.

10. The method of claim 9, wherein the type comprises a data analyzer WN or a data derivation WN.

11. The method of claim 1, further comprising:
storing, by the BAMEx, the set of results files in a local cache; and
sending, by the BAMEx, the set of results files to storage external to the distribution system.

12. The method of claim 1, further comprising:
receiving, by the BAMEx and from a client application, the set of data;
determining a storage location for the set of data based on a heuristic maintained by the data distribution system; and
sending the set of data to the storage location, wherein the storage location is external to the data distribution system.

13. The method of claim 1, further comprising:
sending, by the WN to the JSMS, a notification of a busy status for the WN subsequent to the sending of the job definition to the WN.

14. The method of claim 1, wherein the WN is grouped with at least one other WN of the plurality of WNs to comprise a single entity as viewed by the JSMS.

15. The method of claim 14, further comprising:
grouping, by a job marshaller (JM) of the data distribution system, the WN and the at least one other WN to comprise the single entity.

16. The method of claim 1, wherein the WN comprises a central processing unit (CPU).

17. The method of claim 1, further comprising:
receiving, by the BAMEx and from the client application, a request for the set of results files;
determining, by the BAMEx, a storage location of the set of results files according to a heuristic maintained by the data distribution system;
retrieving, by the BAMEx, the set of results files from the storage location; and
sending, by the BAMEx, the set of results files to the client application.

18. The method of claim 1, wherein a storage location for the set of data, and the storage location for the set of results files, are unknown to the client application.

19. The method of claim 1, wherein the client application refrains from communicating with a storage system for the set of data, and the storage location for the set of results files.

20. The method of claim 1, further comprising:
sending, by the WN and to a common analysis framework (CAF), the set of data; wherein the executing the one or more job functions is performed by the CAF.

21. The method of claim 1, wherein the job definition originates from a client source external to the data distribution system.
